(19) United States
(12) Patent Application Publication
(10) Pub. No.: US 2026/0239419 A1
(43) Pub. Date: Aug. 13, 2026

(54) TECHNIQUES FOR CHANNEL ACCESS IN SHARED SPECTRUM

(71) Applicant: Lenovo (Singapore) Pte. Limited, Singapore (SG)

(72) Inventors: Ali Ramadan Ali, Kraiburg (DE); Karthikeyan Ganesan, Nauheim (DE)

(73) Assignee: Lenovo (Singapore) Pte. Limited, Singapore (SG)

(21) Appl. No.: 19/156,639

(22) PCT Filed: Feb. 15, 2024
(86) PCT No.: PCT/IB2024/051439

§ 371 Date: Aug. 14, 2025

Related U.S. Application Data
(60) Provisional application No. 63/485,375, filed on Feb. 16, 2023.

(51) Int. Cl. H04W 74/0808; H04B 7/04

(52) U.S. Cl. CPC H04W 74/0808; H04B 7/04013

(57) ABSTRACT

Various aspects of the present disclosure relate to a network unit transmitting, to a reconfigurable intelligent surface (RIS) device, a configuration indicating one or both of a set of sensing beams or a set of resources for channel sensing associated with a channel access operation, and receiving, from the RIS device, a report comprising an indication of a result of the channel sensing associated with the performed channel access operation at the RIS device on one or more of the set of sensing beams or the set of resources.

### RELATED APPLICATION

This application claims priority to U.S. Provisional Application Ser. No. 63/485,375 filed Feb. 16, 2023 entitled “Techniques for Channel Access in Shared Spectrum,” the disclosure of which is incorporated by reference herein in its entirety.

### TECHNICAL FIELD

The present disclosure relates to wireless communication, and more specifically to performing a channel access procedure for wireless communication over a shared spectrum (e.g., an unlicensed band).

### BACKGROUND

A wireless communications system may include one or multiple network communication devices, such as base stations, which may be otherwise known as an eNodeB (eNB), a next-generation NodeB (gNB), or other suitable terminology. Each network communication devices, such as a base station may support wireless communications for one or multiple user communication devices, which may be otherwise known as user equipment (UE), or other suitable terminology. The wireless communications system may support wireless communications with one or multiple user communication devices by utilizing resources of the wireless communication system (e.g., time resources (e.g., symbols, slots, subframes, frames, or the like) or frequency resources (e.g., subcarriers, carriers). Additionally, the wireless communications system may support wireless communications across various radio access technologies including third generation (3G) radio access technology, fourth generation (4G) radio access technology, fifth generation (5G) radio access technology, among other suitable radio access technologies beyond 5G (e.g., sixth generation (6G)).

In some wireless communications system that support NR-unlicensed (NR-U), a communication device (e.g., a network entity, a UE, or the like) may perform a channel access procedure, such as a listen before talk (LBT) procedure or clear channel assessment (CCA) procedure, including sensing a channel to determine whether the channel is occupied (e.g., used by other communication devices) or unoccupied (e.g., unused by other communication devices) prior to performing wireless communication (e.g., downlink communication, uplink communication, sidelink communication) on the channel. In some wireless communications system, a reconfigurable intelligent surface (RIS) device may be deployed for communicating (e.g., transmitting, receiving, reflecting, etc.) wireless communication (e.g., control information, data, signals, packets, and the like) between communication devices (e.g., a base station and a UE) in the wireless communications system.

### SUMMARY

According to an aspect of the present disclosure, there is provided a method performed at a network unit, the method comprising: transmitting, to a reconfigurable intelligent surface (RIS) device, a configuration indicating one or both of a set of sensing beams or a set of resources for channel sensing associated with a channel access operation, and receiving, from the RIS device, a report comprising an indication of a result of the channel sensing associated with the performed channel access operation at the RIS device on one or more of the set of sensing beams or the set of resources.

According to another aspect of the present disclosure, there is provided a method performed at a reconfigurable intelligent surface (RIS) device, the method comprising: receiving, from a network unit, a configuration indicating one or both of a set of sensing beams or a set of resources for channel sensing associated with a channel access operation, and transmitting, to the network unit, a report comprising an indication of a result of the channel sensing associated with the performed channel access operation at the RIS device on one or more of the set of sensing beams or the set of resources.

According to another aspect of the present disclosure, there is provided a network unit comprising: a transmitter configured to: transmit, to a reconfigurable intelligent surface (RIS) device, a configuration indicating one or both of a set of sensing beams or a set of resources for channel sensing associated with a channel access operation and a receiver configured to: receiving, from the RIS device, a report comprising an indication of a result of the channel sensing associated with the performed channel access operation at the RIS device on one or more of the set of sensing beams or the set of resources.

According to another aspect of the present disclosure, there is provided a reconfigurable intelligent surface (RIS) device, the RIS device comprising: a receiver configured to receive, from a network unit, a configuration indicating one or both of a set of sensing beams or a set of resources for channel sensing associated with a channel access operation, a transmitter configured to transmit, to the network unit, a report comprising an indication of a result of the channel sensing associated with the performed channel access operation at the RIS device on one or more of the set of sensing beams or the set of resources.

Other aspects are set out in the appended claims.

These and other aspects will be apparent from the embodiments described in the following. The scope of the present disclosure is not intended to be limited by this summary nor to implementations that necessarily solve any or all of the disadvantages noted.

### BRIEF DESCRIPTION OF THE DRAWINGS

For a better understanding of the present disclosure and to show how embodiments may be put into effect, reference is made to the accompanying drawings in which:

FIG. 1 illustrates a wireless communication system that supports a channel access procedure for wireless communication over a shared spectrum in accordance with aspects of the present disclosure.

FIG. 2 is a schematic block diagram of a remote unit that supports a channel access procedure for wireless communication over a shared spectrum in accordance with aspects of the present disclosure.

FIG. 3A is a schematic block diagram of a network unit that supports a channel access procedure for wireless communication over a shared spectrum in accordance with aspects of the present disclosure.

FIG. 3B is a schematic block diagram of a RIS device that supports a channel access procedure for wireless communication over a shared spectrum in accordance with aspects of the present disclosure.

FIG. 4A is a flowchart illustrating a method performed by a network unit that supports a channel access procedure for wireless communication over a shared spectrum in accordance with aspects of the present disclosure.

FIG. 4B is a flowchart illustrating a method performed by a RIS device that supports a channel access procedure for wireless communication over a shared spectrum in accordance with aspects of the present disclosure.

FIG. 5 illustrates a wireless communication system that supports a channel access procedure for wireless communication over a shared spectrum in accordance with aspects of the present disclosure.

FIG. 6 illustrates a wireless communication system that supports a channel access procedure for wireless communication over a shared spectrum in accordance with aspects of the present disclosure.

FIG. 7 illustrates mapping of a transmission beam associated with a network unit to one or more transmission beams associated with a RIS device.

### DETAILED DESCRIPTION

In some cases, such as in 5G New Radio (NR-U), channel access in both downlink and uplink relies on a channel access procedure, such as an LBT procedure or a CCA procedure. A communication device, for example, a network entity (e.g., a base station also referred to as gNB) and/or a UE may first sense a channel (e.g., a communication channel, such as a control channel, data channel, etc.) to ensure that the channel is unoccupied (e.g., there are no on-going communications by other communication devices) prior to any communication to and/or from the communication device. In some other cases, when a channel is a wide bandwidth unlicensed carrier, the communication device may perform a channel access procedure, including detecting one or multiple energy levels on multiple sub-bands of the channel. Although some channel access procedures may be generally effective for the communication device, these channel access procedures lack use of beamforming, for example, for LBT in NR-U and exclusively assume omni-directional LBT.

In some cases, a network entity (e.g., a gNB) is configured to operate in accordance with one or more regulations to sense a channel for performing wireless communication over the channel. In some cases the network entity provides one or more UEs with higher layer parameters (e.g., channelAccessMode2-r17) via system information (e.g., a system information block (SIB), such as SIB1) or a dedicated configuration indicating that a channel access procedure would be performed by UE before transmission(s) on a channel(s). In such cases, channel access procedures outlined below for accessing the channel(s) on which the transmission(s) are performed by the gNB/UE(s), are applied.

When a gNB/UE senses a channel for availability to perform DL/UL transmission(s), the channel for sensing includes at least the corresponding active DL/UL bandwidth part(s) for the DL/UL transmission(s).

When sensing is applicable, the basic unit to perform sensing is a sensing slot with a duration Tₛₗ=5 μs. The channel is considered to be idle for the sensing slot duration Tₛₗ if a gNB or a UE senses the channel during the sensing slot duration and determines that the detected energy after the antenna assembly within the sensing slot duration is less than energy detection threshold X_{Thresh}. Otherwise, the channel is considered busy for the sensing slot duration Tₛₗ.

A maximum gap among a set of DL or UL transmissions in a DL or UL transmission burst, respectively, is 8 μs. For determining a Channel Occupancy Time (COT), if a transmission gap is less than or equal to 8 μs, the gap duration is counted in the channel occupancy time.

The spatial domain filter for sensing beam(s) during the sensing slot duration at the gNB, or at a UE when the UE does not indicate a capability for beam correspondence without the uplink beam sweeping, or at a UE when the UE uses a different beam for sensing than the beam used for transmission, covers the transmission beam(s) of the intended transmission(s) within the channel occupancy.

If a UE indicates a capability for beam correspondence without the uplink beam sweeping and if the UE selects the same sensing beam(s) as the transmission beam(s), the spatial domain filter for sensing beam is determined accordingly.

If a channel occupancy includes transmission(s) in different beams that are multiplexed in spatial domain, one of the followings is applicable for the corresponding sensing to perform the transmission(s) within the channel occupancy:
Type 1 channel access procedure is applied before the start of the channel occupancy using a single sensing beam where the single beam covers all the transmission beams within the channel occupancy. When the channel is accessed, the transmission(s) within the channel occupancy across different beams can occur.
Type 1 channel access procedure is applied before the start of the channel occupancy simultaneously per sensing beam where each sensing beam covers a transmission beam within the channel occupancy. When the channel is accessed, the transmission(s) within the channel occupancy across different beams can occur.

If a channel occupancy includes transmissions in different beams that are multiplexed in time domain, one of the followings is applicable for the corresponding sensing to perform the transmissions within the channel occupancy:
Type 1 channel access procedure is applied before the start of the channel occupancy using a single sensing beam where the single beam covers all the transmissions beams within the channel occupancy. When the channel is accessed, the transmissions within the channel occupancy across different beams can occur.
When the gNB/UE can perform simultaneous sensing in different beams, Type 1 channel access procedure is applied before the start of the channel occupancy per sensing beam where each sensing beam covers a transmission beam within the channel occupancy. When the channel is accessed, the transmission within the channel occupancy across different beams can occur.
When the gNB/UE can perform simultaneous sensing in different beams, Type 1 channel access procedure is applied before the start of the channel occupancy per sensing beam where each sensing beam covers a transmission beam within the channel occupancy. When the channel is accessed, the transmission within the channel occupancy can occur before switching to a different beam within the channel occupancy.

When the gNB intends to transmit a DL transmission(s) across multiple transmission beams, if the gNB performs sensing on the corresponding sensing beam(s) independently, the DL transmission(s) can occur on a transmission beam(s) among the multiple transmission beams if the channel access procedures on the corresponding sensing beam(s) have succeeded, and the channel occupancy would start at the same time across the multiple transmission beams.

When a UE is scheduled by a DCI to transmit a UL transmission(s), the scheduling DCI may indicate the corresponding channel access procedures for the UL transmission(s). The UE determines based on the DCI if Type 1, or Type 2, or Type 3 channel access procedures, is applicable.

When a UE is scheduled with a set of consecutive UL transmissions, the following are applicable:
The UE is not expected to be indicated with different channel access types for any consecutive UL transmissions without gaps in between the transmissions.
If the UE cannot access the channel for a transmission in the set prior to the last transmission according to one of Type 1 or Type 2 channel access procedures, the UE may attempt to transmit the next transmission according to the channel access type indicated in the corresponding UL grant or DL assignment.
If a UE is scheduled to transmit a set of consecutive UL transmissions without gaps including PUSCH using one or more UL grant(s), PUCCH using one or more DL grant(s), or SRS with one or more DL grant(s) or UL grant(s) and the UE transmits one of the scheduled UL transmissions in the set after accessing the channel according to one of Type 1, Type 2, or Type 3 channel access procedures, the UE may continue transmission of the remaining UL transmissions in the set, if any.

In this disclosure, we deal with the channel access mechanism in unlicensed band when a reconfigurable intelligent surface (RIS) device is deployed in the network. As beam-based operation is assumed for unlicensed spectrum in FR2 and beyond, LBT is performed in a specific beam direction(s) at the gNB. In release 17 (Rel. 17), the gNB can share the channel occupancy time (COT) with the user equipment (UE) once the Category 4 (Cat 4) LBT is successful for a certain Tx beam/sensing beam from the gNB, such that the UE uses the configured UL Tx beams or the beam correspondence within the COT for its UL transmission without performing Cat 4 LBT.

The UE needs to perform Cat 2 LBT for its UL transmission in the shared COT if the gap is beyond 16/25 micro sec. However, when a RIS device is deployed in the network, the gNB would have very few backhaul beams with the RIS device to communicate with UEs in different directions, and the results of the directional LBT depends also on the status of a RIS reflection configuration in different time slots, not only on the direction LBT at gNB.

If the RIS surface contains active elements 352 capable of performing reception and baseband processing, the RIS device can be used to perform CCA on its own and can share the results of the CCA with the gNB.

Various aspects of the present disclosure are directed to configuring the RIS controller to perform LBT and to share the LBT results with the network. In the proposed solution, the network configures the RIS device to assist in the LBT operation before the transmission of DL and/or UL, if the RIS device is capable of beam measurement and baseband processing. For example, if some of RIS elements 352 are active, distributed on the surface and connected to RF chain(s) and baseband processor. Note that, with sub-set of RIS elements 352 active, the RIS device can retrieve the channel on the rest of the elements 352, by some processing methods, e.g., with AI/ML algorithms. The LBT may comprise a CCA. CCA is used to determine whether a channel is in use, and thus whether a signal can be transmitted across the channel. A CCA results in a success if a channel is found to be clear, and a failure if the channel is in use. The RIS is configured by the network with spatial information to perform CCA on one or more Rx sensing beams, and is configured to send the results of the LBT success or failure (i.e. a result of the CCA) to the gNB in the UL of the C-link between the RIS device and the gNB, for assisting the transmission in the unlicensed band.

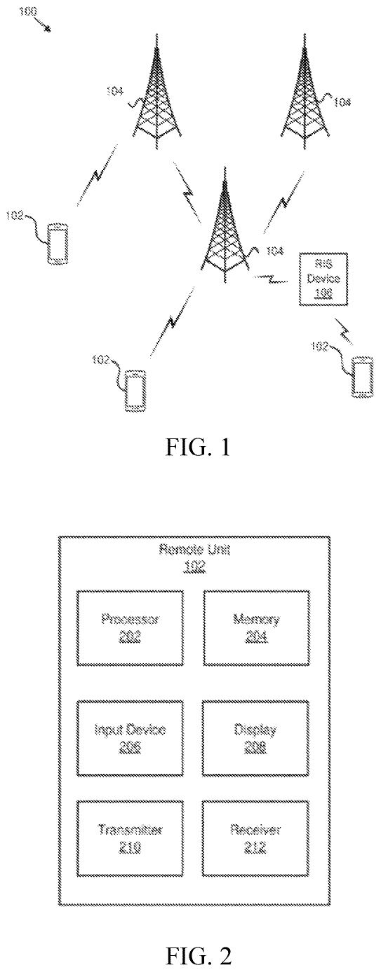

FIG. 1 depicts an embodiment of a wireless communication system. In one embodiment, the wireless communication system 100 includes remote units 102, network units 104, and RIS devices 106. Even though a specific number of remote units 102, network units 104, and RIS devices 106 are depicted in FIG. 1, one of skill in the art will recognize that any number of remote units 102, network units 104, and RIS devices 106 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), IoT devices, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via uplink (“UL”) communication signals and/or the remote units 102 may communicate directly with other remote units 102 via sidelink communication.

The network units 104 may be distributed over a geographic region. In certain embodiments, a network unit 104 may also be referred to as an access point, an access terminal, a base, a base station, a Node-B, an eNB, a gNodeB (“gNB”) , a Home Node-B, a RAN, a relay node, a device, a network device, an integrated and access backhaul (“IAB”) node, a donor IAB node, or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with the 5G or NG (Next Generation) standard of the third generation partnership program (“3GPP”) protocol, wherein the network unit 104 transmits using NG RAN technology. More generally, however, the wireless communication system 100 may implement some other open or proprietary communication protocol, for example, WiMAX, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit downlink (“DL”) communication signals to serve the remote units 102 in the time, frequency, and/or spatial domain.

The RIS devices 106 may be any suitable reconfigurable intelligent surface, such as a smart surface (“SS”), a large intelligent surface (“LIS”), an intelligent reflecting surface (“IRS”), and so forth. A reconfigurable intelligent surface may mean a device having one or more elements (e.g., programmable elements) that are configured to reflect a signal in a manner that the signal is boosted upon reflection.

The network units 104 may communicate with the remote units 102 by transmissions transmitted toward RIS devices 106, with the RIS devices 106 reflecting and boosting the received transmissions that are directed toward the remote units 102. Furthermore, the remote units 102 may communicate with the network units 104 by transmissions transmitted toward RIS devices 106, with the RIS devices 106 reflecting and boosting the received transmissions that are directed toward the network units 104. As may be appreciated, the RIS devices 106 may receive transmissions comprising control signals from one or more network units 104 to control its configuration.

FIG. 2 is a schematic block diagram of a remote unit 102. As shown, the remote unit 102 may include a processor 202, a memory 204, an input device 206, a display 208, a transmitter 210, and a receiver 212. The input device 206 and the display 208 may be combined into a single device, such as a touchscreen. The remote unit 102 may not include any input device 206 and/or display 208.

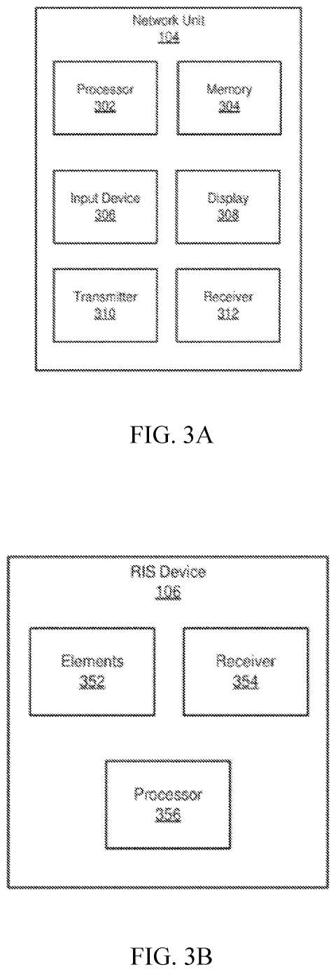

FIG. 3A is a schematic block diagram of a network unit 104. The network unit 104 may include a processor 302, a memory 304, an input device 306, a display 308, a transmitter 310, and a receiver 312. The remote unit 102 may not include any input device 306 and/or display 308.

The processor 302, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”) , an auxiliary processing unit, a field programmable gate array (“FPGA”) , or similar programmable controller. In some embodiments, the processor 302 executes instructions stored in the memory 204 to perform the methods and routines described herein. The processor 302 is communicatively coupled to the memory 304, the input device 306, the display 308, the transmitter 310, and the receiver 312.

The memory 304, in one embodiment, is a computer readable storage medium. In some embodiments, the memory 304 includes volatile computer storage media. For example, the memory 304 may include a RAM, including dynamic RAM (“DRAM”), synchronous dynamic RAM (“SDRAM”), and/or static RAM (“SRAM”). In some embodiments, the memory 304 includes non-volatile computer storage media. For example, the memory 304 may include a hard disk drive, a flash memory, or any other suitable non-volatile computer storage device. In some embodiments, the memory 304 includes both volatile and non-volatile computer storage media. In some embodiments, the memory 304 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 306 may be integrated with the display 208, for example, as a touchscreen or similar touch-sensitive display. In some embodiments, the input device 306 includes a touchscreen such that text may be input using a virtual keyboard displayed on the touchscreen and/or by handwriting on the touchscreen. In some embodiments, the input device 306 includes two or more different devices, such as a keyboard and a touch panel.

The display 308, in one embodiment, may include any known electronically controllable display or display device. The display 308 may be designed to output visual, audible, and/or haptic signals. In some embodiments, the display 308 includes an electronic display capable of outputting visual data to a user. For example, the display 308 may include, but is not limited to, a liquid crystal display (“LCD”) display, an LED display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 308 may be a component of a smart phone, a personal digital assistant, a television, a table computer, a notebook (laptop) computer, a personal computer, a vehicle dashboard, or the like.

In certain embodiments, the display 308 includes one or more speakers for producing sound. For example, the display 308 may produce an audible alert or notification (e.g., a beep or chime). In some embodiments, the display 308 includes one or more haptic devices for producing vibrations, motion, or other haptic feedback. In some embodiments, all or portions of the display 308 may be integrated with the input device 306. For example, the input device 306 and display 308 may form a touchscreen or similar touch-sensitive display. In other embodiments, the display 308 may be located near the input device 306.

Although only one transmitter 310 and one receiver 312 are illustrated, the network unit 104 may have any suitable number of transmitters 310 and receivers 312. The transmitter 310 and the receiver 312 may be any suitable type of transmitters and receivers. In one embodiment, the transmitter 310 and the receiver 312 may be part of a transceiver.

FIG. 3B is a schematic block diagram illustrating a reconfigurable intelligent surface (“RIS”) device 106. The RIS device 106 may include elements 352, a receiver 354, and a processor 356. As may be appreciated, in some embodiments, the processor 356 and the receiver 354 may be substantially similar to the processor 302 and the receiver 312 of the network unit 104, respectively. In various embodiments, the elements 352 include one or more programmable and/or controllable elements. A number of elements 352 may be at least one hundred, at least one thousand, many thousands, and so forth. In certain embodiments, each of the elements 352 may be individually programmed and/or controlled by properties to facilitate reflecting and boosting transmissions that are directed toward a corresponding element. In various embodiments, two or more elements 352 may be grouped together into one or more groups of elements. In such embodiments, the one or more groups of elements may be individually programmed and/or controlled by properties to facilitate reflecting and boosting transmissions that are directed toward elements of the corresponding group. The receiver 354 may be any suitable wireless or wired receiver configured to receive control signals for programming and/or controlling the elements 352. The processor 356 may be any suitable hardware and/or software device that can receive the control signals for programming and/or controlling the elements 352 and provide information to the elements 352 for controlling and/or programming the elements. In some embodiments, the RIS device 106 may have a planar 2 dimensional array of metaatoms (e.g., unit cell, elements) in which each passive element (or group of elements) may be set to one of several states with different reflecting coefficients. Together, the metaatoms give the RIS a macro-property to manipulate an impinge electromagnetic (“EM”) wave and divert it in a direction of an intended receiver. This may improve the performance at the receiver and/or reduce interference to other users.

The RIS device 106 may be associated with a set of sensing beams. The set of sensing beams may comprise one or more sensing beams. Each of the one or more sensing beams used by the RIS device 106 is associated with a configuration of phases of the elements 352. In particular, each sensing beam of the RIS device 106 may correspond to a codebook representing phase coefficients of the elements 352. A sensing beam associated with the RIS device 106 is a beam used to receive a signal which is used in performing a channel access operation (CAO).

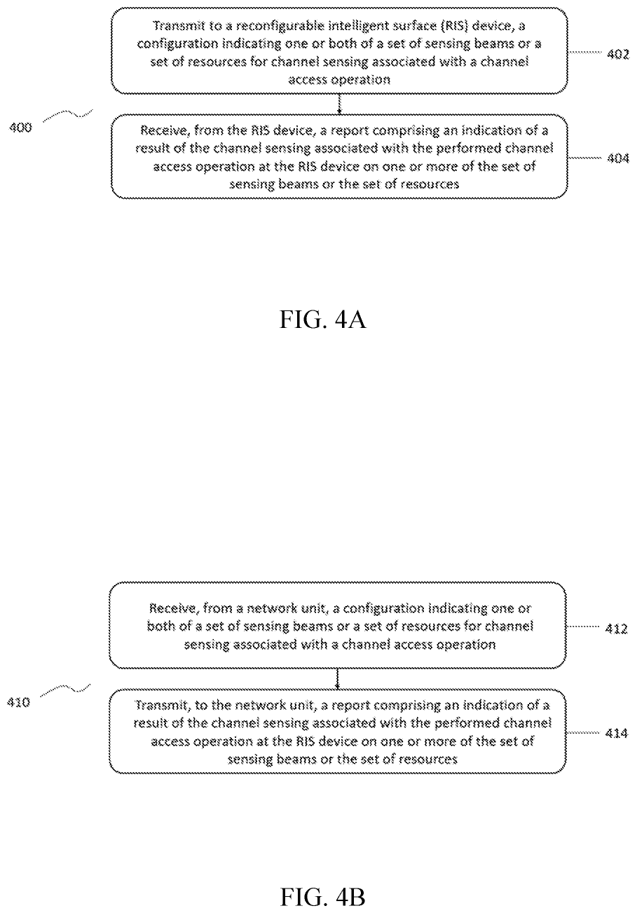

FIG. 4A is a flow diagram showing the steps of a method 400 performed by a gNB 104. It will be appreciated by the skilled reader that any other network unit may be used instead of a gNB 104. For example, the network unit may be a network node of a radio communication network, for example, a base station of a radio communication network. The radio communication network may be a 3GPP 5G New Radio (NR) network. Alternatively, the radio communication network may be any other type of radio communication network.

The method 400 comprises a step 402 transmitting a configuration indicating one or both of a set of sensing beams or a set of resources for channel sensing associated with a CAO (e.g. a CCA procedure).

A CAO may be an LBT. An LBT procedure is a mechanism that allows radio communication systems to share an unlicensed band while maintaining the performance of each individual system. When using LBT, prior to a device transmitting a signal, the device listens to the channel to determine whether the channel is already occupied.

The LBT operation may be any type of LBT operation. For example, the LBT may be a CCA procedure. The LBT procedure may be an autonomous LBT procedure.

CCA is a form of LBT. In a CCA, a device will “listen” for RF transmissions at the physical layer. A signal detect threshold and/or an energy detect threshold may be used to identify any transmissions from another device being transmitted on the to-be evaluated channel.

In step 404, the gNB 104 receives, from the RIS device 106, a report comprising an indication of a result of the channel sensing associated with the performed CAO at the RIS device 106 on one or more of the set of sensing beams or the set of resources.

A corresponding method 410 performed by the RIS is shown in the flow chart in FIG. 4B. The method 410 comprises a step 412 of receiving from the gNB 104, a configuration indicating one or both of a set of sensing beams or a set of resources for channel sensing associated with a CAO.

In step 414, the RIS device 106 transmits, to the network unit, a report comprising an indication of a result of the channel sensing associated with the performed CAO at the RIS device 106 on one or more of the set of sensing beams or the set of resources

The configuration may further comprise a request to the RIS device 106 to provide information on whether the RIS device 106 is capable of performing a COA procedure. The request may comprise a request to provide information on whether the RIS device 106 is capable of beam measurement and/or baseband processing. Before configuring the RIS device to perform the COA procedure, the gNB 104 may request the RIS device 106 to feedback its capability for supporting sensing.

The RIS device 106 may transmit an indication indicating that some of RIS elements 352 are active, distributed on the surface of the RIS device 106 and connected to at least one RF chain and a baseband processor. For example, the RIS device 106 may feedback an indication as to whether it is capable of performing beam measurement and/or baseband processing. According to a first embodiment, the method 400 may comprise a step of receiving, from the RIS device 106, capability information indicating whether the RIS device 106 supports the CAO. The method may further comprise determining that the RIS device 106 supports the CAO based at least in part on the capability information. In this instance, transmission of the configuration may be based at least in part on determining that the RIS device 106 supports the CAO.

According to the method 400, the configuration may be different than a default configuration for the channel sensing associated with the CAO at the RIS device 106. The default configuration may comprise a request for the RIS device 106 to perform a CAO.

In one implementation, in response to the gNB request, the RIS device 106 sends a report of its capability to perform a CAO based on the gNB request.

In another implementation, the capability report for supporting a CAO is included in the capability report of the RIS device 106 during an attach procedure of RIS processor 356 of the RIS device 106. An attach procedure of the RIS device 106 is a procedure in which the RIS device 106 registers with the network in order to receive services from the gNB 104 that require registration. Internet Protocol (IP) connectivity between the RIS device 106 and the gNB 104 may be enabled during the attach procedure. A default Evolved Packet System (EPS) may be established during the attach procedure.

In the capability report, the RIS device 106 sends a set (e.g. a list) of the supported beams for sensing including the beam index and beam type (wide or narrow beam). In other words, the capability information may comprise a list of sensing beams supported by the RIS device 106.

The method may further comprise identifying, at the gNB 104 one or more beams supported by the RIS device 106 for the channel sensing associated with the CAO based at least in part on the capability information. The set of sensing beams may comprise the one or more beams supported by the RIS device 106 for the channel sensing associated with the CAO. The one or more beams may be configured to cover a plurality of transmissions associated with a plurality of transmit beams from the network unit or a user equipment configured to be connected to the network unit or a plurality of reflection beams, or both, at the RIS device 106. A sensing beam applied at the RIS device 106 corresponds to a codebook representing phase coefficients of RIS elements 352 (e.g. from a pre-defined table). The configured sensing beam applied at the RIS device 106 can be associated with a transmit beam for the UE to receive its DL and/or transmit its UL after a successful CAO procedure for the sensing beam. A transmit beam 602 associated with the network unit 104 is shown in FIG. 7. As shown in FIG. 7, the transmit beam 602 is directed towards elements 352 of the RIS device 106. The transmit beam is configured to transmit a signal from the gNB 104 to the UE via the RIS device 106.

The configuration may be transmitted from the gNB 104 to the RIS device 106 in response to the gNB 104 receiving the capability information from the RIS device 106.

The configuration may further comprise sensing information indicating one or a plurality of sensing beams, from the set of sensing beams, to be used in the CAO. This may comprise transmitting an indication of the set of sensing beams semi statically.

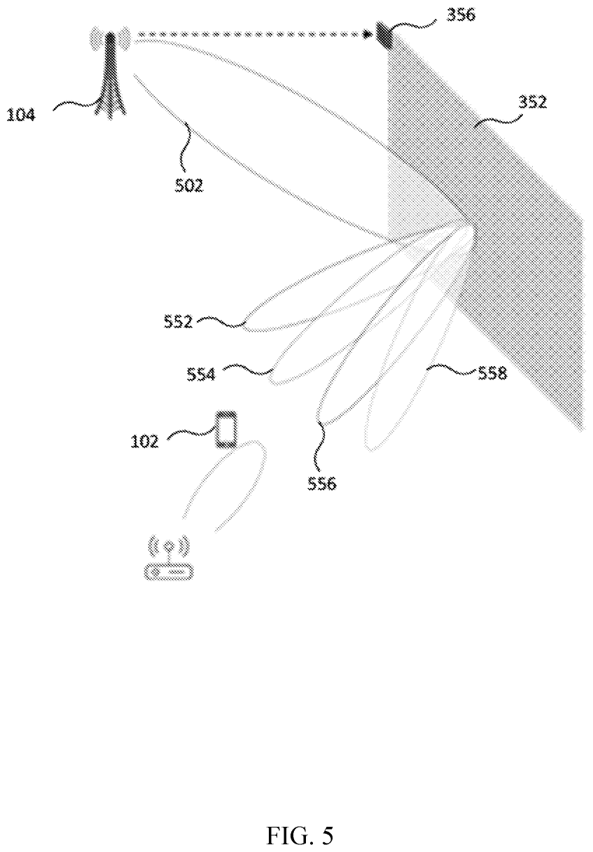

FIG. 5 is a diagram showing a configuration of a RIS device 106 with Rx sensing beams 504 to perform CAO. FIG. 5 illustrates a sensing beam 502 associated with the network unit 104. As shown in FIG. 5, the sensing beam 502 is directed towards elements of the RIS device 106. FIG. 5 further illustrates a set of sensing beams associated with the RIS device 106 comprising a first RIS sensing beam 552, a second RIS sensing beam 554, a third RIS sensing beam 556, and a fourth RIS sensing beam 558. Each of the set of sensing beams associated with the RIS device 106 corresponds to a codebook representing phase coefficients of elements 352. It will be appreciated that the number of sensing beams shown in FIG. 5 is merely an example.

The gNB 104 configures the RIS device 106 with one or more Rx sensing beams for performing CAO from the list of the beams supported by the RIS device 106. The sensing information may indicate that the sensing beam to be used in the CAO is a wide beam 502 that covers multiple potential transmission and/or reflection beams 504 at the RIS device 106. The gNB 104 may configure the RIS device 106 to use sensing beams with wideband CAO operation or sub-band CAO operation in the CAO bandwidth. In this instance, the configuration may further indicate a carrier bandwidth or a sub-band bandwidth for the channel sensing associated with the CAO. Furthermore, the gNB 104 may configure the RIS device 106 with a required Energy Detection (ED) threshold to be used for identifying the success or the failure of CAO, i.e. the configuration may indicate an energy detection (ED) threshold for determining a success or a failure of the result of the channel sensing associated with the performed CAO at the RIS device 106. The ED threshold value can be common for all configured beams for CAO, i.e. a single ED threshold value is configured for all the sensing beams in the list of sensing beams. In this instance, the ED threshold value may be configured for the set of sensing beams. In another aspect, the ED threshold value can be a dedicated ED threshold value for each beam, i.e., an individual ED threshold value is configured for each sensing beam in the list of sensing beams. In this instance, the configuration may indicate a respective ED threshold value for each sensing beam of the set of sensing beams. For example, sensing beams towards the cell edge may be associated with low ED threshold values and beams towards the gNB 104 coverage area may be associated with high ED threshold values.

Along with the indication of the Rx sensing beams with which to perform CAO, the gNB 104 configuration contains time domain resources at which the CAO may be to be performed, i.e. the configuration may further comprise an indication of time domain resources with which to perform the CAO. The resources comprise one or more time slots for the channel sensing associated with the CAO. In these example implementations, the configuration may comprise at least one row index, each of the at least one index corresponding to a row in the preconfigured table comprising a time resource, a sensing beam of the set of sensing beams associated with the gNB 104, and one or more sensing beams of the set of sensing beams associated with the RIS device 106 to be used by the RIS device 106 at the time resource. In these example implementations, it is the preconfigured table which stores for each time resource: (i) a RIS sensing beam index corresponding to phase coefficients of elements 352 to be applied by the RIS device 106 to produce the one or more sensing beams of the set of sensing beams associated with the RIS device 106; and (ii) a gNB sensing beam index corresponding to phase coefficients of elements 352 to be applied by the RIS device 106 to produce a sensing beam of the set of sensing beams associated with the network unit.

One or more of the time resources may be associated with a single sensing beam of the set of sensing beams associated with the RIS device 106. One or more of the time resources may be associated with a plurality of sensing beams of the set of sensing beams associated with the RIS device 106. A plurality of sensing beams to be applied by the RIS device 106 in a single time resource may be applied using different elements 352 of the RIS device 106.

For each time resource, the processor 356 is configured to use the RIS sensing beam index to obtain the corresponding phase coefficients of elements 352 to be applied by the RIS device 106 to produce the one or more sensing beams of the set of sensing beams associated with the RIS device 106. For example, the processor 356 may query a table stored in memory accessible to the RIS device 106, the table storing a mapping of beam indexes to coefficients (phase values of the RIS elements 352).

The sensing beam(s) to be applied by the RIS device 106 in a first time resource, may be different to the sensing beam(s) to be applied by the RIS device 106 in a second later time resource. The elements 352 used to apply the sensing beam(s) in the first time resource may be the same as those used to apply the sensing beam(s) in the second time resource. Alternatively, the elements 352 used to apply the sensing beam(s) in the first time resource may be different to those used to apply the sensing beam(s) in the second time resource.

Upon receiving the second indication, the RIS processor 356 may switch the surface to receive signals on the configured beams and start the CAO and energy detection based on the configured ED threshold(s).

The gNB 104 configures the RIS processor 356 with uplink (UL) resources to feedback the CAO results, e.g. on Uplink Control Information (UCI) via Physical Uplink Shared Channel (PUSCH)/Physical Uplink Control Channel (PUCCH) of the C-link between the RIS processor 356 and the gNB 104.

In one implementation, the feedback, i.e. the report, comprises a respective result of the channel sensing associated with the performed CAO at the RIS device 106 on each sensing beam of the set of sensing beams, and wherein the respective result comprises a bit field indicating a failure or a success of the CAO at the RIS device 106 for each sensing beam of the set of sensing beams, that is, the report comprises a list of configured Rx sensing beams together with 1 bit of information that identifies the failed or successful CAO for each beam. In another implementation the RIS processor 356 feeds back the indexes list of Rx beams with the success CAO or the list of Rx beams with failed CAO, i.e. the report comprises either a list of sensing beams with successful CAO or a list of sensing beams with failed CAO. Upon receiving the feedback, the gNB 104 can initiate the channel occupancy time COT(s) for the beams with successful CAO and share it with a user equipment (UE). The RIS device 106 may autonomously prevent the Tx transmit beams corresponding to Rx sensing beams with failed CAO from being reflected until it received further information from the gNB 104.

According to an embodiment, the gNB 104 may configure the RIS device 106 with a set of Rx sensing beams for performing CAO at the RIS device 106 and another set of Rx sensing beams for performing CAO at the gNB 104 on a backhaul sensing beam. According to this embodiment, the gNB 104 provides the RIS device 106 with a selection of a first set of sensing beams for performing CAO from the RIS device 106, and the gNB 104 selects a second set of sensing beams with which to perform backhaul CAO from the gNB 104. In this instance, the set of sensing beams may comprise a first subset of sensing beams for the channel sensing associated with the CAO at the RIS device 106, and the set of sensing beams may comprise a second subset of sensing beams for a respective channel sensing associated with a respective backhaul CAO.

According to an embodiment, if multiple segments of the RIS device 106 can be used to communicate with UE(s), the gNB 104 configures the RIS device 106 with multiple Rx sensing beams to perform CAO from multiple segments. The RIS device 106 can be configured to perform CAO on the Rx sensing beams in TDM from different segments, or simultaneously using all segments together, and is configured with UL resources to feedback the result of the CAO for the multiple segments.

According to a second embodiment, the RIS device 106 is allowed to perform CAO on any beam, even if it is not configured by the gNB 104, if some of RIS elements 352 are active and connected to RF chain(s) and baseband processor. For example, for communication with a UE, the gNB 104 may configure the RIS device 106 with Tx transmission beams (e.g., CSI-RS beams dedicated to a UE for beam refinement/selection) and time domain resources to reflect the signal towards the UE. In this case, configuration information sent to the RIS device 106 may comprise a request to the RIS device 106 to perform CAO based on the transmission beams transmitted by the gNB 104. This may comprise transmitting configuration information indicating for the RIS device 106 to perform the CAO based at least in part on a set of transmit beams associated with the network unit. The indication (i.e. configuration) may be carried by RIS dedicated downlink control information (DCI) in the C-link between the gNB 104 and the RIS processor 356. The downlink control information (DCI) may comprise configuration information for the RIS device 106.

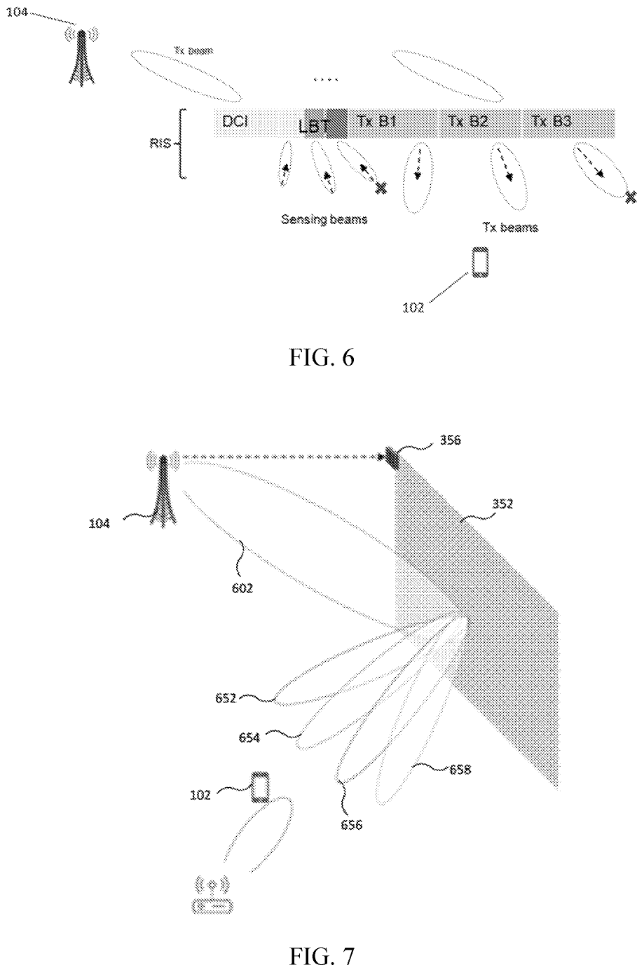

Upon receiving the configuration related to the Tx beam reflection, if there is a gap between the reception of the DCI that carries the configuration of the Tx beam indexes and the actual transmission/reception slots of these beams at the RIS device 106, the RIS device 106 is configured to perform CAO before switching the surface to reflect the configured beams as shown in FIG. 6.

The RIS device 106 can apply CAO in a time division multiplexing (TDM) manner on an Rx sensing beam corresponding to a configured Tx beam. Upon receipt of the CAO results, the RIS device 106 may use the Tx beams with a successful CAO for forwarding the downlink (DL) signal to the UE and is allowed to skip the Tx beam(s) with a failed CAO procedure without waiting for an indication from the gNB 104. In this instance, the configuration may indicate for the RIS device 106 to select, one or more transmit beams of the set of transmit beams for communicating with a user equipment (UE) configured to be connected to the network unit, or skip one or more transmit beams of the set of transmit beams based at least in part on the channel sensing associated with the performed CAO at the RIS device 106.

The RIS device 106 may inform the gNB 104 about the already skipped beam(s). If there is no gap between the reception of the DCI and the actual transmission on the first beam, the RIS device 106 can skip the CAO for the first beam, and performs CAO for the rest of the beams while forwarding the first beam to the UE. This depends on whether the RIS elements 352 used for sensing are separated from the elements 352 used for the reflection of the signal and whether the elements 352 for sensing can form a sensing beam corresponding to the Tx beam. The gNB 104 may receive an indication from the RIS device 106 indicating which transmission beams have been skipped.

According to an embodiment, the RIS device 106 may be configured to perform CAO on Rx sensing beams not yet configured by the gNB 104 for transmission. Upon the successful CAO for one or more beams, the RIS device 106, according to one implementation, shares the information of the possible occupation of the channel on the sensed beams along with the index of the sensed beam(s) as a type of channel occupancy time (COT) sharing, so that the gNB 104 doesn't need to perform CAO or configure the RIS device 106 to perform CAO within the shared COT(s) once the gNB 104 wants to configure the corresponding Tx beam(s) for the communication with the UE within that COT. In another implementation, the RIS device 106 shares the beam indexes with failed CAO, so that gNB 104 avoids configuring such beam(s) for transmission to the UE.

The described procedure is proposed to configure and share CAO results with a RIS device 106 for assisting with communication in the unlicensed band. The procedure includes configuration of a RIS device 106 with sensing Rx sensing beams to be used for CCA at the RIS device 106. The procedure includes sharing the CAO results with the gNB 104 for the sensing beams at the RIS device 106. Configuration to allow the RIS device 106 to autonomously perform CAO, and to select the Tx beams based on the results of the CAO is provided.

Additional aspects of the techniques, features, and/or methods discussed herein relate to one or more of the following:

A method performed at a network unit, the method comprising: transmitting, to a reconfigurable intelligent surface (RIS) device, a configuration indicating at least one of a set of sensing beams or a set of resources for channel sensing associated with a channel access operation; and receiving, from the RIS device, a report comprising an indication of a result of the channel sensing associated with the channel access operation at the RIS device on one or more of the set of sensing beams or the set of resources.

A method performed at a reconfigurable intelligent surface (RIS) device, the method comprising: receiving, from a network unit, a configuration indicating at least one of a set of sensing beams or a set of resources for channel sensing associated with a channel access operation; and transmitting, to the network unit, a report comprising an indication of a result of the channel sensing associated with the channel access operation at the RIS device on one or more of the set of sensing beams or the set of resources.

A network unit, comprising: at least one memory; and at least one processor coupled with the at least one memory and configured to cause the network unit to: transmit, to a reconfigurable intelligent surface (RIS) device, a configuration indicating at least one of a set of sensing beams or a set of resources for channel sensing associated with a channel access operation; and receive, from the RIS device, a report comprising an indication of a result of the channel sensing associated with the channel access operation at the RIS device on one or more of the set of sensing beams or the set of resources.

Alternatively, or in addition to the above-described network unit, any one or combination of: the at least one processor is configured to cause the network unit to: receive, from the RIS device, capability information indicating whether the RIS device supports the channel access operation; and determine that the RIS device supports the channel access operation based at least in part on the capability information, and wherein to transmit the configuration is based at least in part on that the RIS device supports the channel access operation. The at least one processor is configured to cause the network unit to identify one or more beams supported by the RIS device for the channel sensing associated with the channel access operation based at least in part on the capability information, and wherein the set of sensing beams comprises the one or more beams supported by the RIS device for the channel sensing associated with the channel access operation. The at least one processor is configured to cause the network unit to transmit an indication of the set of sensing beams semi-statically. The set of resources comprise one or more time slots for the channel sensing associated with the channel access operation. The configuration further indicates a carrier bandwidth or a sub-band bandwidth for the channel sensing associated with the channel access operation. The configuration indicates an energy detection (ED) threshold for determining a success or a failure of the result of the channel sensing associated with the channel access operation at the RIS device. The report comprises a respective result of the channel sensing associated with the channel access operation at the RIS device on each sensing beam of the set of sensing beams, and wherein the respective result comprises a bit field indicating a failure or a success of the channel access operation at the RIS device for each sensing beam of the set of sensing beams. The set of sensing beams comprises a first subset of sensing beams for the channel sensing associated with the channel access operation at the RIS device, and wherein the set of sensing beams comprises a second subset of sensing beams for a respective channel sensing associated with a respective backhaul channel access operation. The at least one processor is configured to cause the network unit to transmit configuration information indicating for the RIS device to perform the channel access operation based at least in part on a set of transmit beams associated with the network unit.

A reconfigurable intelligent surface (RIS) device, the RIS device comprising: at least one memory; and at least one processor coupled with the at least one memory and configured to cause the RIS to: receive, from a network unit, a configuration indicating at least one of a set of sensing beams or a set of resources for channel sensing associated with a channel access operation; and transmit, to the network unit, a report comprising an indication of a result of the channel sensing associated with the channel access operation at the RIS device on one or more of the set of sensing beams or the set of resources.

Alternatively, or in addition to the above-described RIS device, any one or combination of: the at least one processor is configured to cause the RIS to transmit, to the network unit, capability information indicating whether the RIS device supports the channel access operation, and wherein to receive the configuration is based at least in part on the RIS device supporting the channel access operation. The set of sensing beams comprises one or more beams supported by the RIS device for the channel sensing associated with the channel access operation. The resources comprise one or more time slots for the channel sensing associated with the channel access operation. The configuration further indicates a carrier bandwidth or a sub-band bandwidth for the channel sensing associated with the channel access operation. The configuration indicates an energy detection (ED) threshold for determining a success or a failure of the result of the channel sensing associated with the channel access operation at the RIS device. The report comprises a respective result of the channel sensing associated with the channel access operation at the RIS device on each sensing beam of the set of sensing beams, and wherein the respective result comprises a bit field indicating a failure or a success of the channel access operation at the RIS device for each sensing beam of the set of sensing beams. The set of sensing beams comprises a first subset of sensing beams for the channel sensing associated with the channel access operation at the RIS device, and wherein the set of sensing beams comprises a second subset of sensing beams for a respective channel sensing associated with a respective backhaul channel access operation.

1. A method performed by a network unit, the method comprising:
transmitting, to a reconfigurable intelligent surface (RIS) device, a configuration indicating at least one of a set of sensing beams or a set of resources for channel sensing associated with a channel access operation; and
receiving, from the RIS device, a report comprising an indication of a result of the channel sensing associated with the channel access operation at the RIS device on one or more of the set of sensing beams or the set of resources.

2. A method performed by a reconfigurable intelligent surface (RIS) device, the method comprising:
receiving, from a network unit, a configuration indicating at least one of a set of sensing beams or a set of resources for channel sensing associated with a channel access operation; and
transmitting, to the network unit, a report comprising an indication of a result of the channel sensing associated with the channel access operation at the RIS device on one or more of the set of sensing beams or the set of resources.

3. A network unit for wireless communication, comprising:
at least one memory; and
at least one processor coupled with the at least one memory and configured to cause the network unit to:
transmit, to a reconfigurable intelligent surface (RIS) device, a configuration indicating at least one of a set of sensing beams or a set of resources for channel sensing associated with a channel access operation; and
receive, from the RIS device, a report comprising an indication of a result of the channel sensing associated with the channel access operation at the RIS device on one or more of the set of sensing beams or the set of resources.

4. The network unit of claim 3, wherein the at least one processor is configured to cause the network unit to:
receive, from the RIS device, capability information indicating whether the RIS device supports the channel access operation; and
determine that the RIS device supports the channel access operation based at least in part on the capability information, and wherein to transmit the configuration is based at least in part on the RIS device supports the channel access operation.

5. The network unit of claim 4, wherein the at least one processor is configured to cause the network unit to identify one or more beams supported by the RIS device for the channel sensing associated with the channel access operation based at least in part on the capability information, and wherein the set of sensing beams comprises the one or more beams supported by the RIS device for the channel sensing associated with the channel access operation.

6. The network unit of claim 3, wherein the at least one processor is configured to cause the network unit to transmit an indication of the set of sensing beams semi-statically.

7. The network unit of claim 3, wherein the set of resources comprise one or more time slots for the channel sensing associated with the channel access operation.

8. The network unit of claim 3, wherein the configuration further indicates a carrier bandwidth or a sub-band bandwidth for the channel sensing associated with the channel access operation.

9. The network unit of claim 3, wherein the configuration indicates an energy detection (ED) threshold for determining a success or a failure of the result of the channel sensing associated with the channel access operation at the RIS device.

10. The network unit of claim 3, wherein the report comprises a respective result of the channel sensing associated with the channel access operation at the RIS device on each sensing beam of the set of sensing beams, and wherein the respective result comprises a bit field indicating a failure or a success of the channel access operation at the RIS device for each sensing beam of the set of sensing beams.

11. The network unit of claim 3, wherein the set of sensing beams comprises a first subset of sensing beams for the channel sensing associated with the channel access operation at the RIS device, and wherein the set of sensing beams comprises a second subset of sensing beams for a respective channel sensing associated with a respective backhaul channel access operation.

12. The network unit of claim 3, wherein the at least one processor is configured to cause the network unit to transmit configuration information indicating for the RIS device to perform the channel access operation based at least in part on a set of transmit beams associated with the network unit.

13. A reconfigurable intelligent surface (RIS) device, comprising:
at least one memory; and
at least one processor coupled with the at least one memory and configured to cause the RIS to:
receive, from a network unit, a configuration indicating at least one of a set of sensing beams or a set of resources for channel sensing associated with a channel access operation; and
transmit, to the network unit, a report comprising an indication of a result of the channel sensing associated with the channel access operation at the RIS device on one or more of the set of sensing beams or the set of resources.

14. The RIS device of claim 13, wherein the at least one processor is configured to cause the RIS to transmit, to the network unit, capability information indicating whether the RIS device supports the channel access operation, and wherein to receive the configuration is based at least in part on the RIS device supporting the channel access operation.

15. The RIS device of claim 14, wherein the set of sensing beams comprises one or more beams supported by the RIS device for the channel sensing associated with the channel access operation.

16. The RIS device of claim 13, wherein the resources comprise one or more time slots for the channel sensing associated with the channel access operation.

17. The RIS device of claim 13, wherein the configuration further indicates a carrier bandwidth or a sub-band bandwidth for the channel sensing associated with the channel access operation.

18. The RIS device of claim 13, wherein the configuration indicates an energy detection (ED) threshold for determining a success or a failure of the result of the channel sensing associated with the channel access operation at the RIS device.

19. The RIS device of claim 13, wherein the report comprises a respective result of the channel sensing associated with the channel access operation at the RIS device on each sensing beam of the set of sensing beams, and wherein the respective result comprises a bit field indicating a failure or a success of the channel access operation at the RIS device for each sensing beam of the set of sensing beams.

20. The RIS device of claim 13, wherein the set of sensing beams comprises a first subset of sensing beams for the channel sensing associated with the channel access operation at the RIS device, and wherein the set of sensing beams comprises a second subset of sensing beams for a respective channel sensing associated with a respective backhaul channel access operation.
